(19) United States
(12) Patent Application Publication
(10) Pub. No.: US 2011/0119384 A1
(43) Pub. Date: May 19, 2011

(54) INFORMATION PROCESSING APPARATUS, INFORMATION PROCESSING PROGRAM, AND INFORMATION PROCESSING METHOD

(75) Inventors: Kenji Morimoto, Tokyo (JP); Yuji Wada, Kawasaki (JP); Masazumi Matsubara, Kawasaki (JP); Hiroshi Otsuka, Kawasaki (JP); Yasuhide Matsumoto, Kawasaki (JP); Yukihiro Watanabe, Kawasaki (JP); Kuniaki Shimada, Kawasaki (JP); Akira Katsuno, Kawasaki (JP)

(73) Assignee: FUJITSU LIMITED, Kawasaki-shi (JP)

(21) Appl. No.: 12/979,143

(22) Filed: Dec. 27, 2010

Related U.S. Application Data
(63) Continuation of application No. PCT/JP2008/062201, filed on Jul. 4, 2008.

(51) Int. Cl. G06F 15/173

(52) U.S. Cl. 709/226

(57) ABSTRACT

The information processing apparatus includes: a specification information reception unit that receives specification information for specifying a predetermined one of a plurality of resources; a determination unit that determines a device managing the resource specified by the specification information from among a plurality of devices based on the specification information received by the specification information reception unit; a specification information notification unit that sends the specification information to the device that has been determined, by the determination unit, to manage the resource specified by the specification information; an association unit that associates plural pieces of resource information with one another based on the sent resource information; and a resource information processing unit that executes predetermined processing for the resource information based on the association among the plural pieces of resource information associated by the association unit.

### CROSS-REFERENCE TO RELATED APPLICATIONS

This application is a continuation application, filed under 35 U.S.C. §111(a), of PCT Application No. PCT/JP2008/062201, filed Jul. 4, 2008, the disclosure of which is herein incorporated in its entirety by reference.

### FIELD

The present invention relates to an FCMDB that integrally manages information constituting an information system.

### BACKGROUND

There is known an FCMDB system (Federated Configuration Management Database system) as a database that virtually integrates a plurality of types of databases for managing information concerning hardware and software constituting an information system to thereby manage information of resources (configuration information) constituting a system. As illustrated in FIG. 19, the FCMDB system is constituted by MDRs (Management Data Repositories) which are each an element database for retaining configuration information and a database FCMDB for integrally managing the MDRs.

The configuration information is managed by being distributed in a plurality of the MDRs in a redundant manner. The FCMDB receives registration of information from the MDR and manages the configuration information of the entire information system in the form of values or location (pointer) of the information.

The FCMDB performs name identification on information registered from the plurality of MDRs for each item to determine redundancy of information and which information it should retain as main information, and retains meta-information indicating which MDR is main or which MDR is sub.

A client of the FCMDB system uses a pub/sub (publish/subscribe) framework illustrated in FIG. 20 to read out information from the FCMDB system. The client sends, as Subscriber, a request of monitoring configuration information to be monitored (Subscription, specification information). The MDR serving as a management source issues, as Publisher, Notification in response to event occurrence so that the temporal accuracy of the monitoring is not affected by information update frequency between the FCMDB and MDR. The FCMDB mediates, as Broker, between the client (Subscriber) and MDR (Publisher) and sends a message concerning event occurrence corresponding to the configuration information monitoring request (Notification, resource information). In the pub/sub (publish/subscribe) framework, the Publisher or Subscriber sometimes performs some part of the function of the Broker acting as the link between the Publisher and Subscriber. Also in the FCMDB system, the MDR serving as the Publisher issues a message concerning only the Notification corresponding to the content of previously sent Subscription.

There is disclosed, as a prior art relating to the present invention, a method that distributes composite Subscription and registers logic for combining a plurality of Notifications (refer to, e.g., Patent Document 1).

### [Patent Document 1] Japanese Laid-open Patent Publication No. 2004-348680

However, the Subscription is sent to all the MDRs, so that unnecessary configuration information monitoring task occurs in an MDR which does not retain configuration information to be monitored or an MDR which retains configuration information to be monitored but update from which is invalidated by a policy of the FCMDB due to redundancy with other MDRs, that is, an MDR unrelated to the content of the Subscription.

Further, information is distributed in a plurality of the MDRs in a redundant manner, the same Notification is issued from the plurality of MDRs that retain configuration information for one event, resulting in occurrence of unnecessary communication.

Further, even in the case where there is some sort of association among a plurality of events, the MDR issues only Notification corresponding to events concerning the configuration information that the MDR itself manages at a timing according to monitoring state of each event, resulting in occurrence of unnecessary communication. This prevents the Subscriber from promptly utilizing the association among the plurality of received Notifications, causing waiting time.

Further, application of the technique disclosed in Patent Document 1 does not satisfy the requirements of the present invention in the first place. That is, in the technique of Patent Document 1, the Subscriptions are not explicitly combined, and logic to be given is not specific. Thus, it is not possible to solve the problems concerning an increase in a load involved with check processing of a monitoring target in the sending of the Subscription or distribution of the Notification and concerning the waste of communication traffic involved with distribution of redundant Notifications.

### SUMMARY

In order to solve the above problems, according to an aspect of the present invention, there is provided an information processing apparatus capable of managing a plurality of resources in a distributed manner and connecting to a plurality of devices sending resource information concerning the plurality of managed resources, the information processing apparatus including: a specification information reception unit that receives specification information for specifying a predetermined one of the plurality of resources; a determination unit that determines a device managing the resource specified by the specification information from among the plurality of devices based on the specification information received by the specification information reception unit; a specification information notification unit that sends the specification information to the device that has been determined, by the determination unit, to manage the resource specified by the specification information; an association unit that associates plural pieces of resource information with one another based on the sent resource information; and a resource information processing unit that executes predetermined processing for the resource information based on the association among the plural pieces of resource information associated by the association unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of the outline of an FCMDB system according to an embodiment of the present invention;

FIG. 2 is a view illustrating an example of the outline of functions of the FCMDB system according to the present embodiment;

FIG. 3 is a view illustrating a configuration information DB according to the present embodiment;

FIG. 4 is a view illustrating an example of the configuration information according to the present embodiment described in an XML;

FIG. 5 is a view illustrating an example of a registration source DB according to the present embodiment;

FIG. 6 is a view illustrating an example of a resource-type based DB according to the present embodiment;

FIG. 7 is a view illustrating an example of a Subscription distribution record DB according to the present embodiment;

FIG. 8 is a view illustrating an example of a Notification record DB according to the present embodiment;

FIG. 9 is a view illustrating an example of a Notification association DB according to the present embodiment;

FIG. 10 is a view illustrating an example of a Notification processing stand-by DB according to the present embodiment;

FIG. 11 is a view illustrating an example of the outline of distribution processing of Subscription according to the present embodiment in the case where a monitoring target is the addition of a structure;

FIG. 12 is a view illustrating an example of the outline of distribution processing of Subscription according to the present embodiment in the case where the range of a monitoring target includes sub-trees;

FIG. 13 is a flowchart illustrating an example of processing in the distribution processing of Subscription according to the present embodiment performed by a Subscription distribution determination unit;

FIG. 14 is a flowchart illustrating a (first) example of processing performed by an association detection unit according to the present embodiment;

FIG. 15 is a flowchart illustrating a (second) example of processing performed by the association detection unit according to the present embodiment;

FIG. 16 is a flowchart illustrating a (third) example of processing performed by the association detection unit according to the present embodiment;

FIG. 17 is a view illustrating an example of the outline of discarding, combining, and demanding processing of Notification according to the present embodiment;

FIG. 18 is a flowchart illustrating an example of processing performed by a notification processing determination unit according to the present embodiment;

FIG. 19 is a view for explaining the outline of conventional functions of the FCMDB system; and

FIG. 20 is a view for explaining the outline of conventional processing of monitoring/notification of a pub/sub (publish/subscribe) type.

### DESCRIPTION OF EMBODIMENT

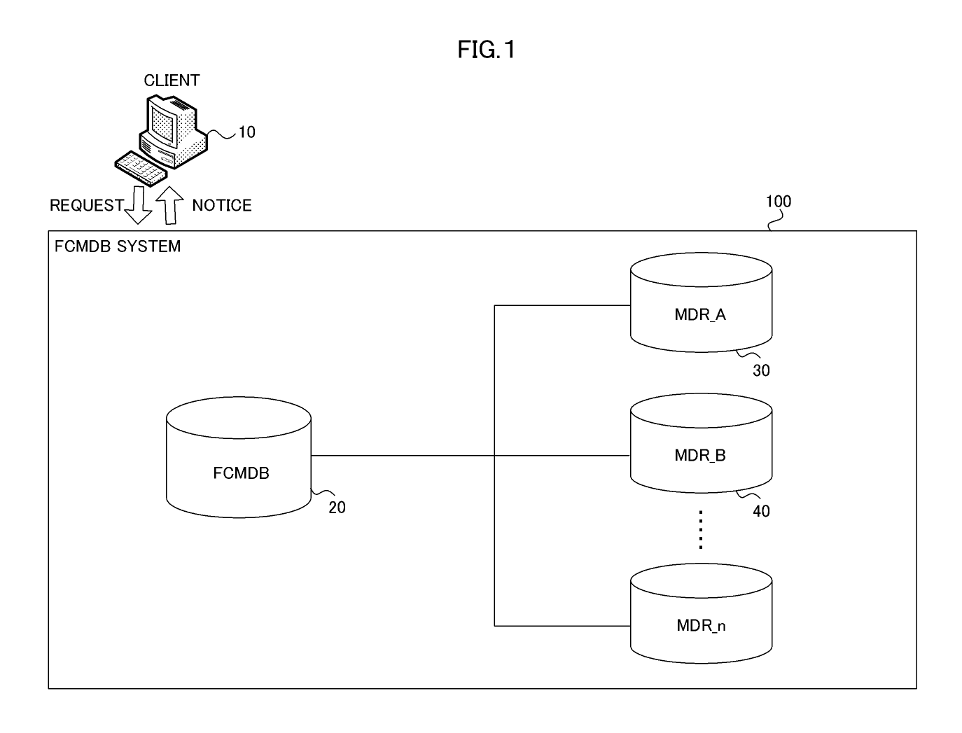

An embodiment of the present invention will be described below with reference to the accompanying drawings. FIG. 1 illustrates an example of the outline of an FCMDB system according to the present embodiment.

In the present embodiment, an FCMDB system 100 that manages information of resources constituting an information system (information concerning hardware or software constituting an information system, which is hereinafter referred to as “configuration information”) and a client 10 that utilizes management information are connected to each other through a network.

The FCMDB system 100 has a plurality of types of databases for managing configuration information of a not-illustrated information system, including an MDR_A30 (device), an MDR_B40 (device), and the like, and a database FCMDB 20 (information processing apparatus) that virtually integrates the plurality of types of databases to manage configuration information of the entire information system. The FCMDB sometimes plays the same role as the MDR in the FCMDB system.

In the present embodiment, an information processing apparatus, an information processing program, and an information processing method to which a pub/sub (publish/subscribe) framework is applied will be described. In this configuration, a client 10 acts as Subscriber, the MDR_A30 and the like each act as Publisher, and the FCMDB 20 acts as Broker.

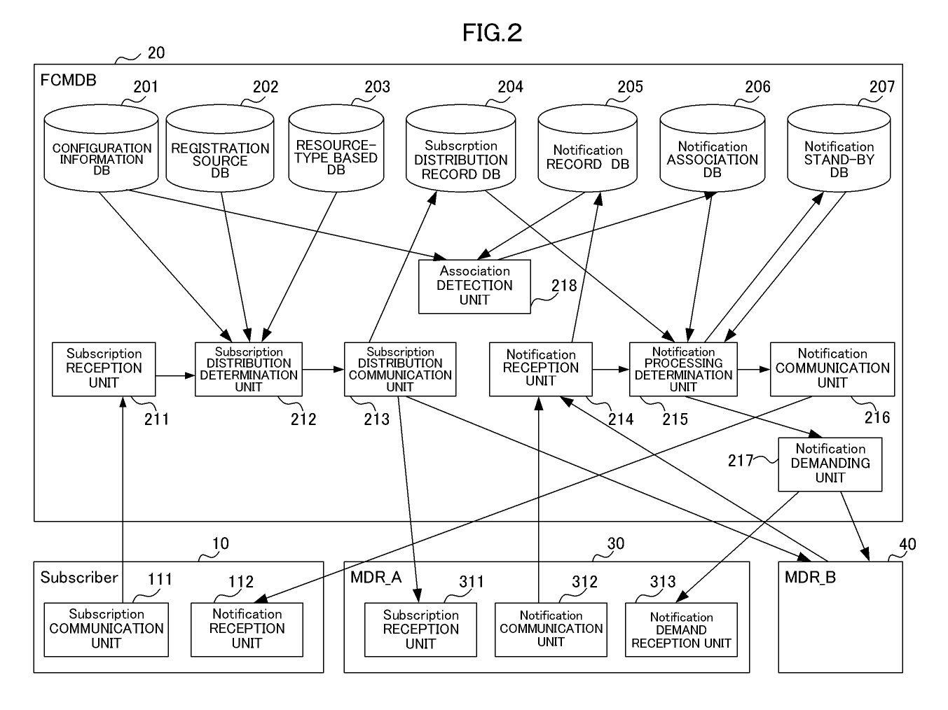

FIG. 2 is an example of a functional block diagram illustrating the FCMDB 20, MDR_A30, MDR_B40, and a Subscriber 10 serving as the client according to the present embodiment.

The Subscriber 10 has a Subscription (specification information) communication unit 111 for sending a monitoring request and a Notification (resource information) reception unit 112 for receiving notification concerning a change in a monitoring target.

The FCMDB 20 has a configuration information DB 201, a registration source DB 202, a resource-type based DB 203, a Subscription distribution record DB 204, a Notification record DB 205, a Notification association DB 206, a Notification stand-by DB 207, a Subscription reception unit 211 (specification information reception unit) for receiving Subscription, a Subscription distribution determination unit 212 (determination unit) for determining a distribution destination of Subscription, a Subscription distribution communication unit 213 (specification information notification unit) for distributing Subscription, a Notification reception unit 214 for receiving distribution of the Notification, a Notification processing determination unit 215 (resource information processing unit) for determining combining or disposal concerning the Notification, a Notification communication unit 216 for distributing the Notification, a Notification demanding unit 217 for demanding distribution of the Notification, and an association detection unit 218 (association unit) for defining and generating association among a plurality of Notifications (association among plural pieces of resource information).

The MDR_A30 and the like each have a Subscription reception unit 311 for receiving Subscription, a Notification communication unit 312 for distributing the Notification, and a Notification demand reception unit 313 for receiving a demand of the Notification.

The outline of information retained in the FCMDB 20 will be described below.

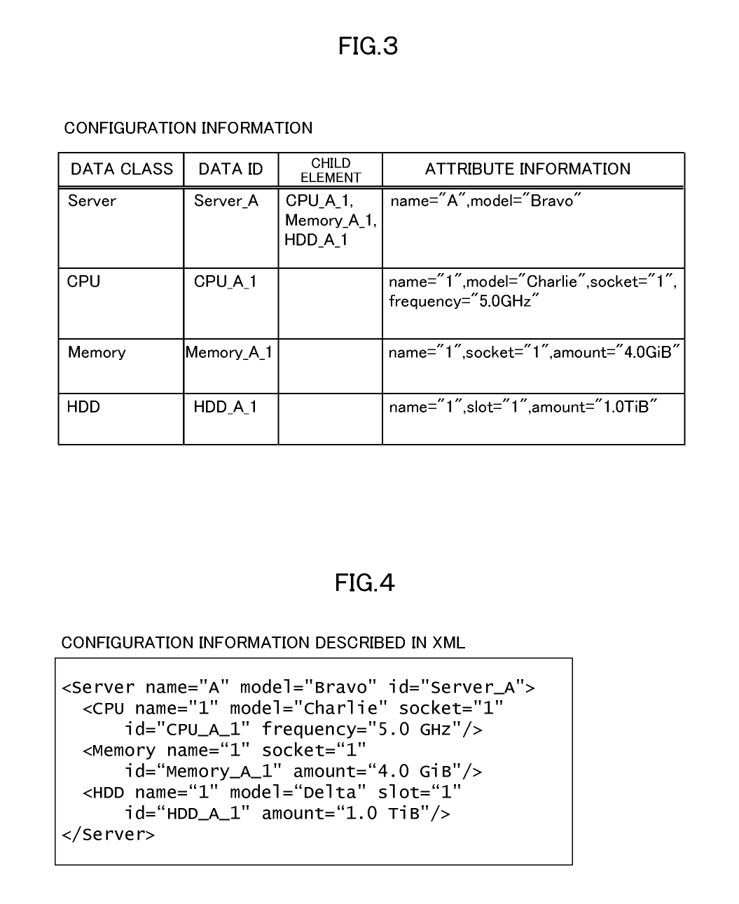

FIG. 3 illustrates an example of the configuration information DB 201 for managing configuration information of an information system. The configuration information is composed of a set of type (data class) of a resource to be managed, value (data ID) of a resource, child element of a resource, and attribution information of a resource. FIG. 4 illustrates an example of the configuration information described in an XML.

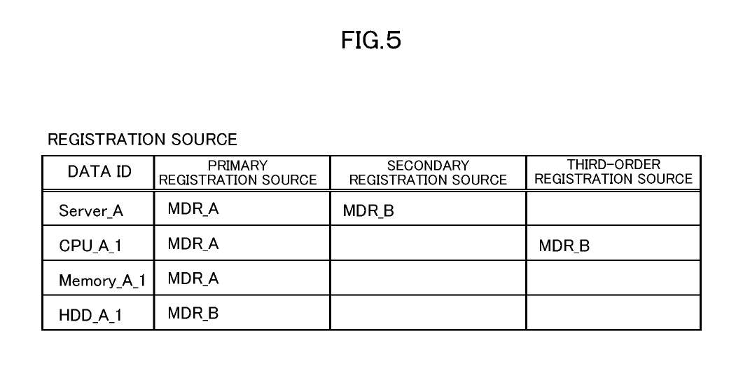

FIG. 5 illustrates an example of the registration source DB 202 for managing configuration information registration source meta-information which is information concerning a management source of a resource to be managed by an information system. A plurality of management sources concerning the management target are divided according their management priority into three levels: Primary, Secondary, and Third-order, and the configuration information registration source meta-information is composed, for each management target, of a set of value of a resource type (data ID), registration source (primary registration source) that performs management as a primary registration source, registration source (secondary registration source) that performs management as a secondary registration source, and registration source (third-order registration source) that performs management as a third-order registration source.

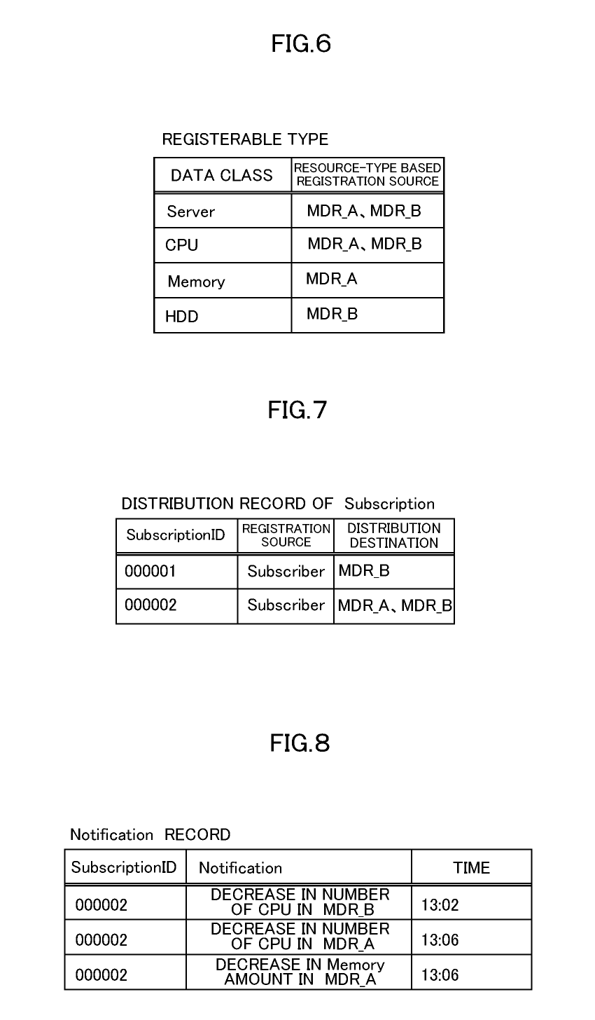

FIG. 6 illustrates an example of the resource-type based DB 203 for managing a management source that may perform resource-type based registration. The information of the management source that may perform the resource-type based registration is composed, for each type of a resource to be managed, of a set of resource type (data class) and management source (resource-type based registration source) that may register the resource type.

FIG. 7 illustrates an example of the Subscription distribution record DB 204 for managing a history of distribution of registration of a monitoring request made through Subscription. The record of the distribution of Subscription is composed of a set of an ID of Subscription, a registration source of Subscription, and a distribution destination of Subscription.

FIG. 8 is an example of the Notification record DB 205 in which received Notifications are recorded in chronological order. The record of Notification is composed of a set of ID of Subscription corresponding to received Notification, content of Notification, and reception time of Notification.

FIG. 9 illustrates an example of the Notification association DB 206 for managing association among a plurality of Notifications. The management of association among Notifications is represented by processing of discarding or combining Notification (hereinafter, referred to as “subsequent Notification”) associated with Notification (hereinafter, referred to as “preceding Notification”) that has previously been received and effective time before reception of subsequent Notification. The Notification association is composed of a set of preceding Notification, subsequent Notification, processing applied to subsequent Notification, and effective time before reception of subsequent Notification.

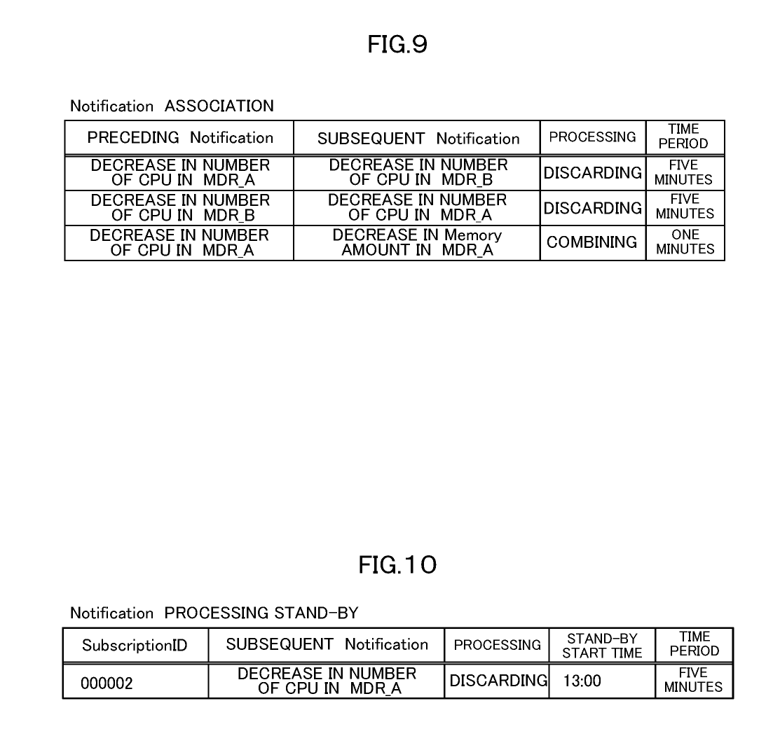

FIG. 10 illustrates an example of the Notification processing stand-by DB 207 for recording a subsequent Notification processing stand-by state. The Notification processing stand-by state is a state where reception of subsequent Notification and processing for subsequent Notification are waited for after existence of relevant subsequent Notification is determined from management information of the Notification association DB 206 at the time when preceding Notification concerning target Subscription is received. The record of the Notification processing stand-by state is composed of a set of ID of Subscription corresponding to Notification, subsequent Notification in a processing stand-by state, processing for subsequent Notification, subsequent Notification processing stand-by start time, and effective stand-by time before reception of subsequent Notification.

The functions described above are realized by hardware resources such as a CPU, a memory, and a hard disk provided in the client 10 and FCMDB system 100 and software cooperating with each other.

The outline of operation of the FCMDB 20 will next be described.

The FCMDB 20 receives a monitoring request (Subscription) from the Subscriber 10, determines the MDR to be monitored based on the content of the monitoring request, and distributes Subscription to the MDR. Further, the FCMDB 20 receives Notification from each MDR serving as Publisher, discards, combines, and demands Notification based on the record of distribution of Subscription, association detected among a plurality of Notifications, Notification processing stand-by state, and content of Notification, and distributes Notification to the Subscriber. Furthermore, the FCMDB 20 performs processing of detecting association among a plurality of Notifications at an arbitrary timing in order to realize the abovementioned discarding, combining, and demanding of Notification.

The distribution processing of Subscription will next be described.

The distribution destination of Subscription is determined based on what the monitoring target is. The FCMDB 20 in the present embodiment has conventionally been configured to manage information (refer to registration source DB 202) indicating by which MDR each instance (specification resource) is managed. In the present embodiment, the FCMDB 20 further manages information (refer to resource-type based DB 203) indicating which MDR has information concerning each class (arbitrary resource).

Based on the above information, in the case where a monitoring target is addition of a structure, the FCMDB 20 determines, based on the resource-type based DB 203, the MDR concerning the class corresponding to the monitoring target and then distributes Subscription.

In the case where a monitoring target is deletion of a structure, the FCMDB 20 determines, based on the registration source DB 202, the MDR associated with the instance to be monitored and then distributes Subscription. In the case where a given MDR is newly associated with the instance to be monitored in the future, the FCMDB 20 accordingly distributes Subscription to such an MDR. When determining the MDR, the FCMDB 20 refers to the registration source DB 202 in such a manner so as to be able to specify, as meta-information of each class or meta-information of Subscription, whether only the primary MDR or both the primary and secondary MDRs are included in the determination result.

In the case where a monitoring target is a change in a value, the FCMDB 20 distributes Subscription in the same manner as in the case of the deletion of a structure.

In the case where the range of a monitoring target includes sub-trees (for example, not only one resource of a specified server A but also two or more resources such as a CPU, a memory, and an HDD and further resources located below the resources mentioned), the FCMDB 20 makes determination on each element within the sub-tree; while in the case where there is no information for making a decision, the FCMDB 20 distributes Subscription based on determination of the parent element.

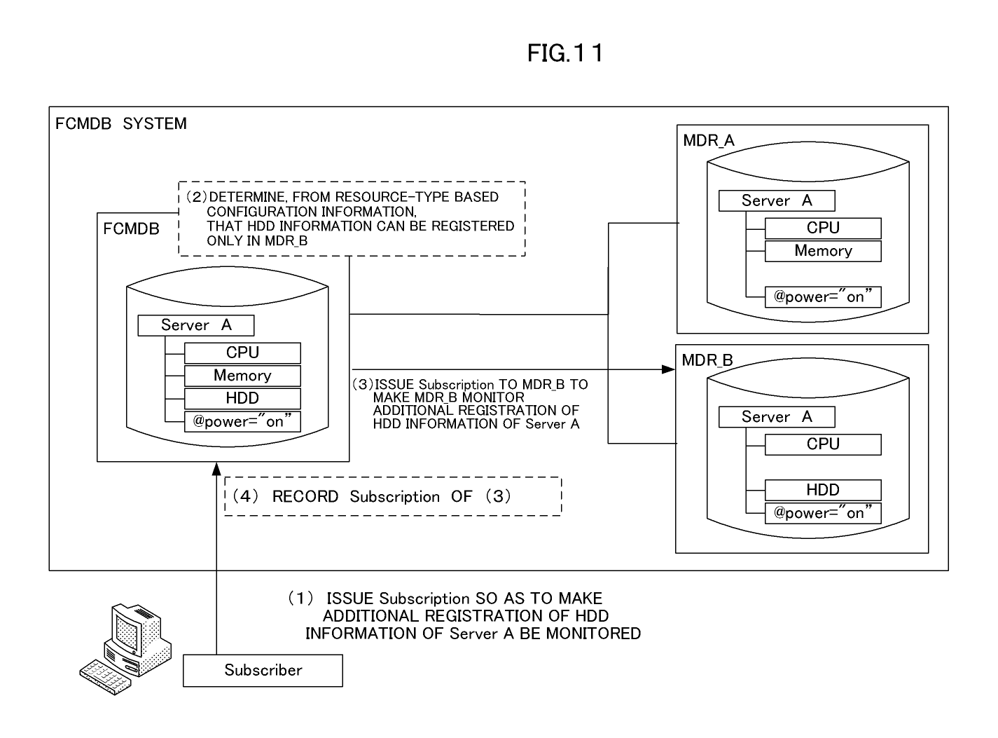

FIG. 11 illustrates an example of the outline of the distribution processing of Subscription in the case where a monitoring target is the addition of a structure. For example, in the case where a monitoring request on additional registration of HDD information of a Server A is made, the Subscriber 10 issues, to the FCMDB 20, Subscription requesting monitoring of additional registration of HDD information of the Server A. The FCMDB 20 determines, from the resource-type based DB 203, that the HDD information may be registered only in the MDR_B40, issues Subscription to the MDR_B40 so as to make the MDR_B40 monitor the additional registration of HDD information of the server A, and records the distribution of Subscription.

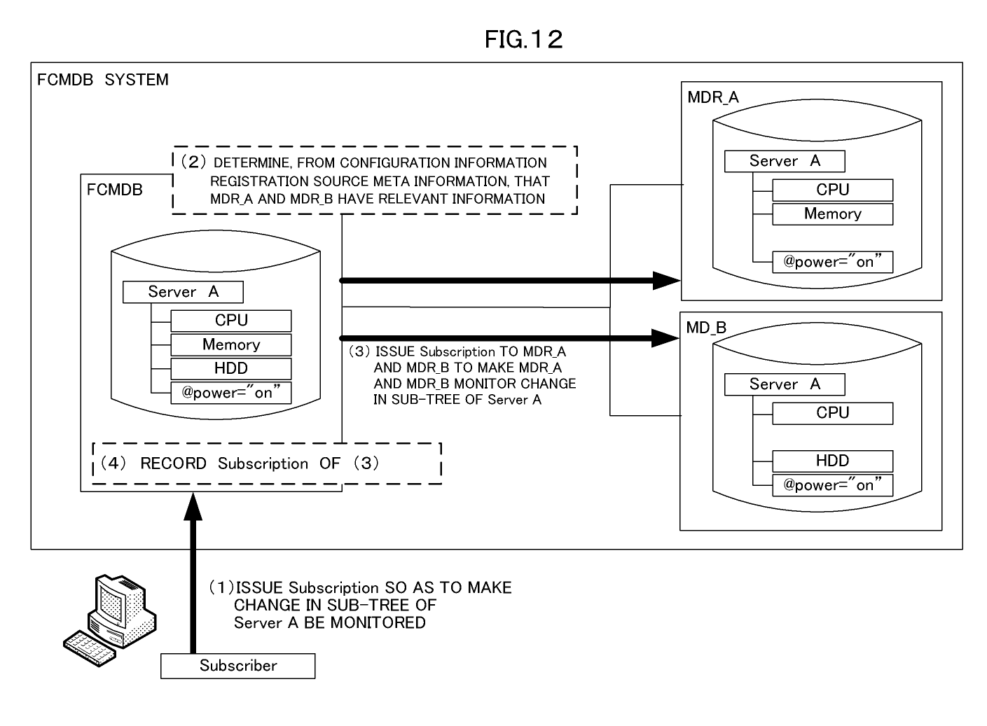

FIG. 12 illustrates an example of the outline of distribution processing of Subscription in the case where the range of a monitoring target includes sub-trees. For example, in the case where a monitoring request on a change in the resources in the sub-tree of the server A is made, the Subscriber 10 issues, to the FCMDB 20, Subscription requesting monitoring of a change in the resources in the sub-tree of the Server A. The FCMDB 20 determines, from the registration source DB 202, that the MDR_A30 and MDR_B40 have the information concerning the Server A, issues Subscription to the MDR_A30 and MDR_B40 so as to make the MDR_A30 and MDR_B40 monitor a change in the resources in the sub-tree of the server A, and records the distribution of Subscription.

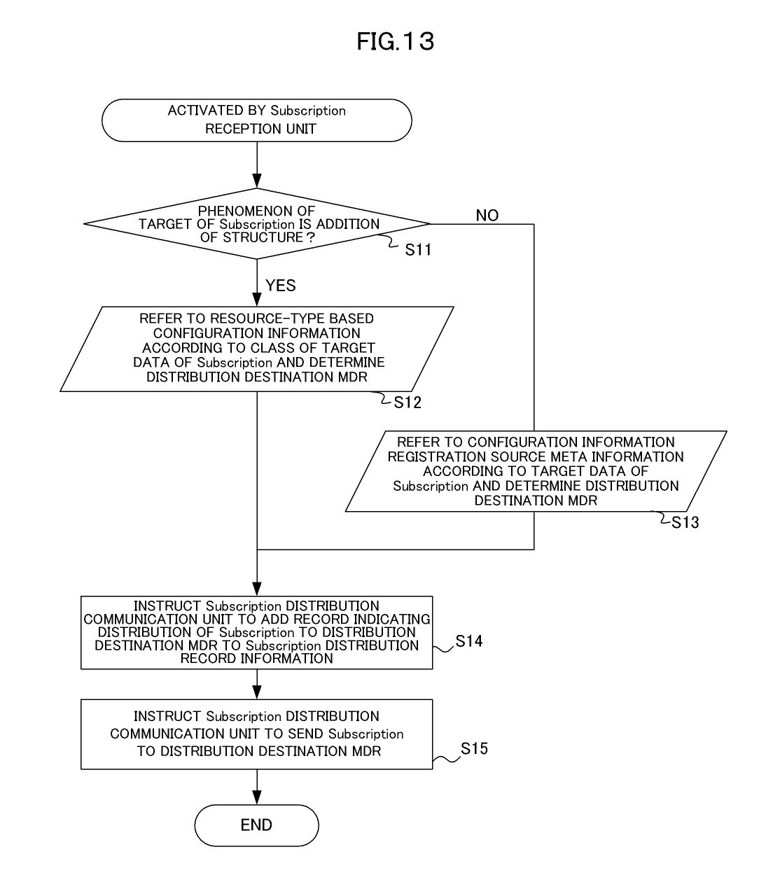

FIG. 13 is a flowchart illustrating an example of processing in the distribution processing of Subscription performed by the Subscription distribution determination unit 212.

The Subscription reception unit 211 receives Subscription from the Subscription communication unit 111 and activates the Subscription distribution determination unit 212 (specification information reception step).

The Subscription distribution determination unit 212 determines, from the content of Subscription, whether a phenomenon of the monitoring target is the addition of a structure (S11). When determining that a phenomenon of the monitoring target is the addition of a structure (YES in S11), the Subscription distribution determination unit 212 refers to the resource-type based DB 203 according to the class of a resource to be monitored and determines a distribution destination MDR (S12, determination step). All MDRs are determined as distribution destination when there is no information corresponding to the resource-type based DB 203 (determination step).

Then, the Subscription distribution determination unit 212 instructs the Subscription distribution communication unit 213 to add a record indicating the distribution of Subscription to the Subscription distribution record DB 204 (S14) and to send Subscription to the distribution destination MDR (S15, specification information notification step), and this flow is ended.

On the other hand, in the case where a phenomenon of the monitoring target is not the addition of a structure (NO in S11), the Subscription distribution determination unit 212 refers to the registration source DB 202 according to a resource to be monitored and determines a distribution destination MDR (S13, determination step), and then the flow advances to step S14.

The abovementioned distribution processing of Subscription allows limitation of the MDR to which Subscription is sent, reducing load involved in the monitoring processing of the MDR. Further, load on the Broker involved in the Notification processing is also reduced.

Processing of detecting a definition of association among changes in the values or structures of a plurality of monitoring targets or association among a plurality of Notifications will next be described.

This processing is performed at a predetermined timing before combining, discarding, and demanding processing of Notification. It is assumed in performing this processing that the record indicating the distribution of Subscription described in the abovementioned distribution processing of Subscription has already been made and that information specifying corresponding Subscription is included in Notification.

The definition of association among changes in the values or structures of a plurality of monitoring targets specifies that subsequent Notification that indicates an event associated with an event that preceding Notification indicates exists within a certain time period. Specifically, for example, the definition states that “Notification indicating that the power of a server instance has been tuned off follows within five minutes in correspondence with Notification indicating run level of an OS instance has become 5”.

The detection of association among a plurality Notifications is processing of extracting, from a history in which generated Notifications are retained in chronological order, management target elements which are close to each other in terms of data structure of the FCMDB system, making a hypothesis concerning occurrence of Notification that, for example, “Notification concerning an element B will be generated within n minutes following Notification concerning an element A”, and verifying the hypothesis concerning occurrence of Notification based on the history.

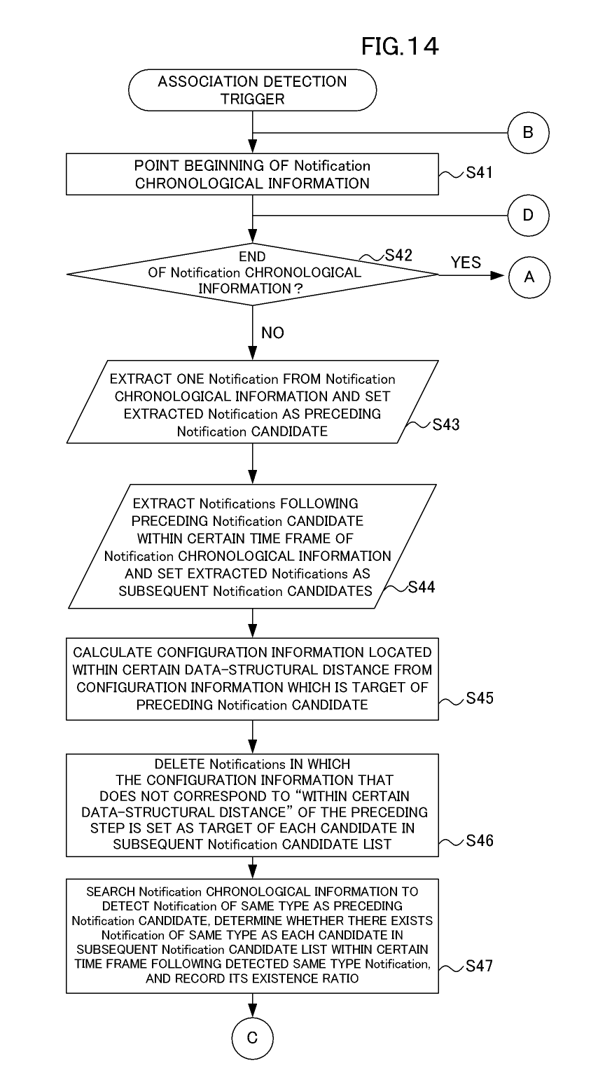

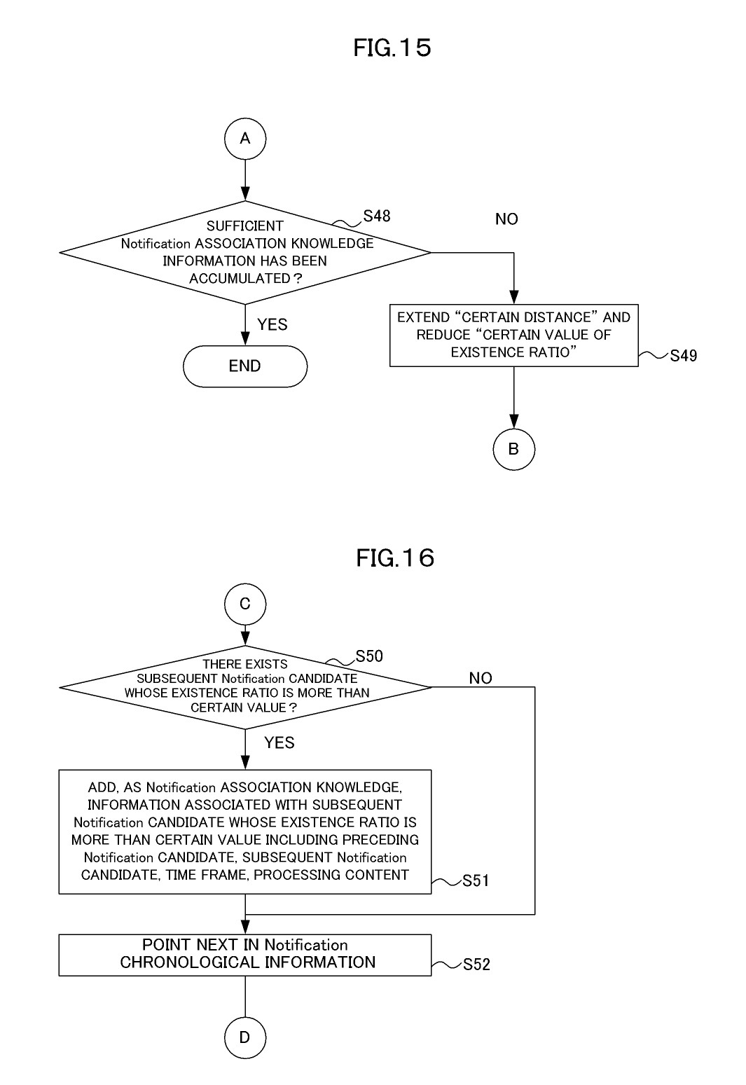

FIGS. 14, 15, and 16 are each a flowchart illustrating an example of processing of detecting association among a plurality of Notifications performed by the association detection unit 218.

The association detection unit 218 activates the flow of this processing upon request of a processing scheduler in the FCMDB system or client. The association detection unit 218 points the beginning of the Notification record DB 205 (S41) and starts this processing.

The association detection unit 218 determines whether the record of Notification is located at the end of the Notification record DB 205 (S42). When determining that the record of Notification is not located at the end of the Notification record DB 205 (NO in S42), the association detection unit 218 extracts one Notification from the Notification record DB 205, sets the extracted Notification as a preceding Notification candidate (S43), extracts Notifications following the preceding Notification candidate within a certain time frame, and sets the extracted Notifications as subsequent Notification candidates (S44, association step).

Then, the association detection unit 218 calculates configuration information “within a certain data-structural distance” from configuration information which is the monitoring target of the preceding Notification candidate (S45) and deletes Notifications in which the configuration information that does not correspond to “within a certain data-structural distance” is set as the monitoring target from the list of the subsequent Notification candidates (S46).

Then, the association detection unit 218 searches the Notification record DB 205 to detect Notification of the same type as the preceding Notification candidate, determines whether there exists Notification of the same type as each candidate in the subsequent Notification candidate list in the Notification group within a certain time frame following the detected same type Notification, and calculates and records the existence ratio (ratio of appearance of Notification of the same type as each of the subsequent Notification candidates to the number of appearance of Notifications of the same type as the preceding Notification candidate) for each of the subsequent Notification candidate (S47, association step).

Then, the association detection unit 218 determines whether there exists subsequent Notification candidate whose existence ratio is more than a certain value (S50). When determining that there exists subsequent Notification candidate whose existence ratio is more than a certain value (YES in S50), the association detection unit 218 adds, as Notification association knowledge, information associated with the subsequent Notification candidate whose existence ratio is more than a certain value including the preceding Notification candidate, subsequent Notification candidate, time frame, processing content to the Notification association DB 206 (S51, association step) and points next in the Notification record DB 205 (S52), the flow returns to step S42. On the other hand, in the case where there exists no candidate (NO in S50), the flow returns to step S42 after step S52.

On the other hand, when determining that the record of Notification is located at the end of the Notification record DB 205 (YES in S42), the association detection unit 218 determines whether sufficient Notification association knowledge information has been accumulated in the Notification record DB 205 (S48). In the case where sufficient Notification association knowledge information has been accumulated (YES in S48), this flow is ended. On the other hand, in the case where sufficient Notification association knowledge information has not been accumulated (NO in S48), the association detection unit 218 extends “a certain distance” of the “within a certain data-structural distance” used in step S45 and reduces “a certain value of the existence ratio” of the same type Notification used in step S50 (S49), and the flow returns to step S41.

The discarding, combining, and demanding processing of Notification will next be described.

This processing is executed based on the abovementioned definition of association among changes in the values or structures of a plurality of monitoring targets and association among detected Notifications. It is assumed in performing this processing that association corresponding to the distributed subscription occurs.

In the case where Notification redundant with given Notification in terms of the same element may follow the given Notification, the FCMDB sends Notification to the Subscriber while storing the content of Notification and discards the subsequent redundant Notification.

In the case where Notification follows given Notification in the same sub-tree, the FCMDB urges the Publisher to distribute subsequent Notification, receives the subsequent Notification, combines the content of the given Notification and subsequent Notification, and sends the combined Notification to the Subscriber.

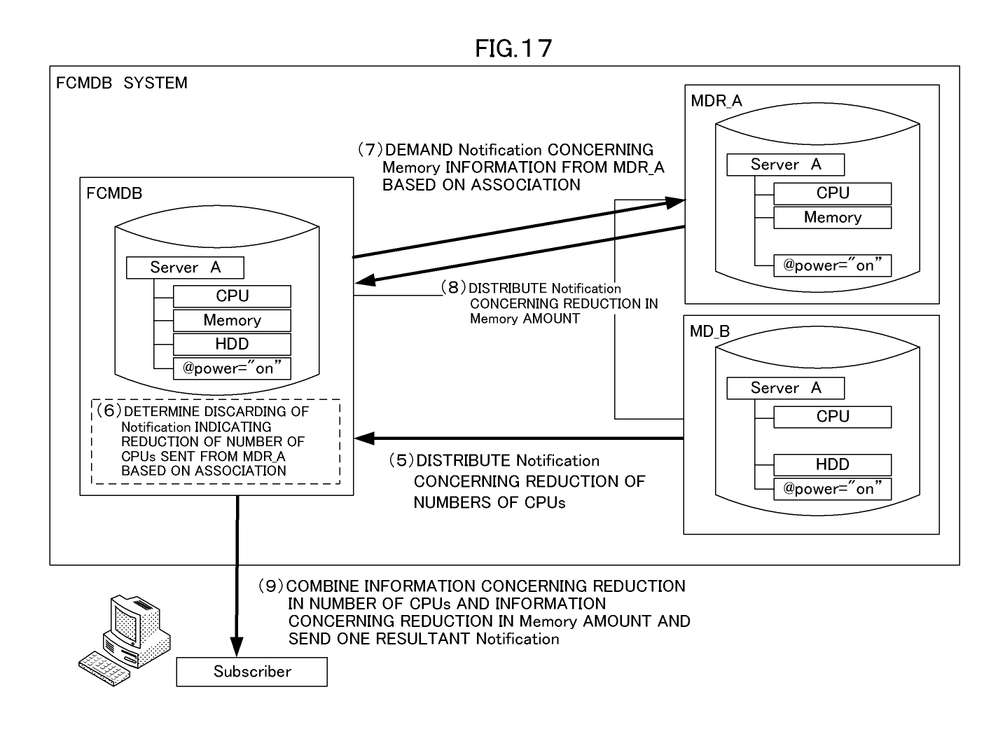

FIG. 17 illustrates an example of the outline of discarding, combining, and demanding processing of Notification in the embodiment of the present invention. As illustrated, when the MDR_B40 detects a reduction in the number of CPUs, the MDR_B40 distributes Notification concerning the reduction of the numbers of CPUs. Upon reception of the Notification, the FCMDB 20 determines discarding of the Notification indicating the reduction of the number of CPUs sent from the MDR_A30 and demands Notification concerning memory information from the MDR_A30 based on the association among Notifications. In response to the demanding for Notification concerning memory information, the MDR_A30 confirms a change in the memory amount and distributes Notification concerning a reduction in the memory amount. The FCMDB 20 combines information concerning the reduction in the number of CPUs and information concerning a reduction in the memory amount and sends one Notification to the Subscriber.

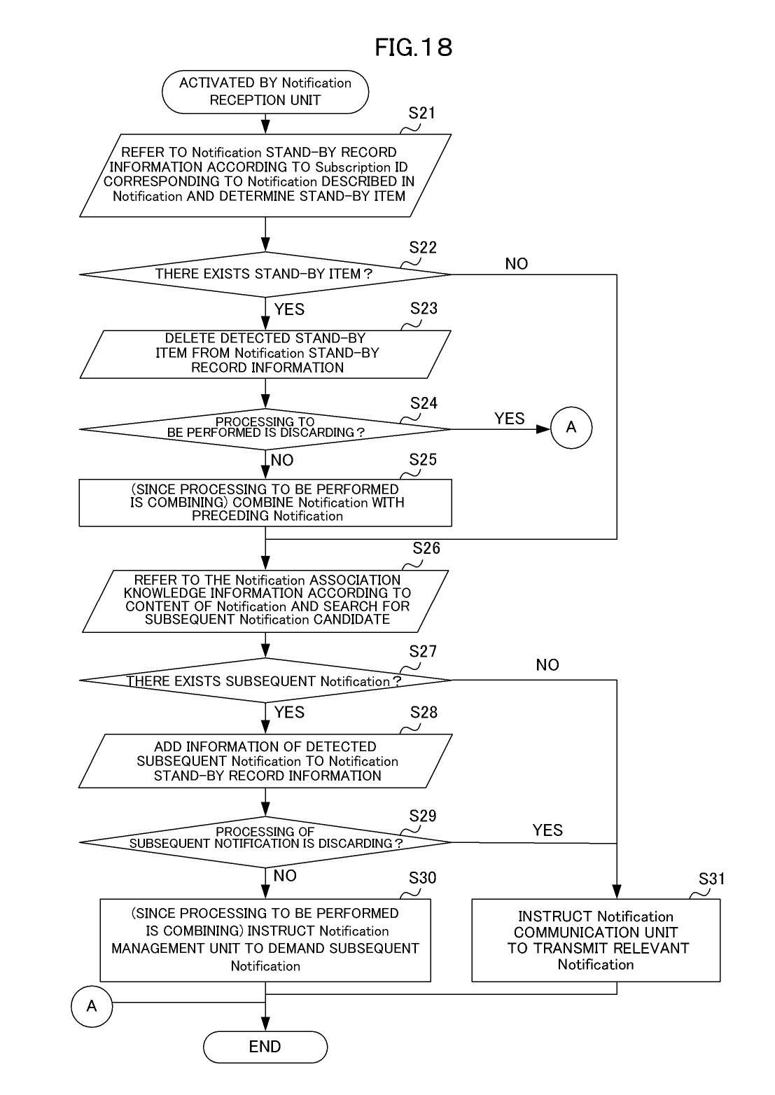

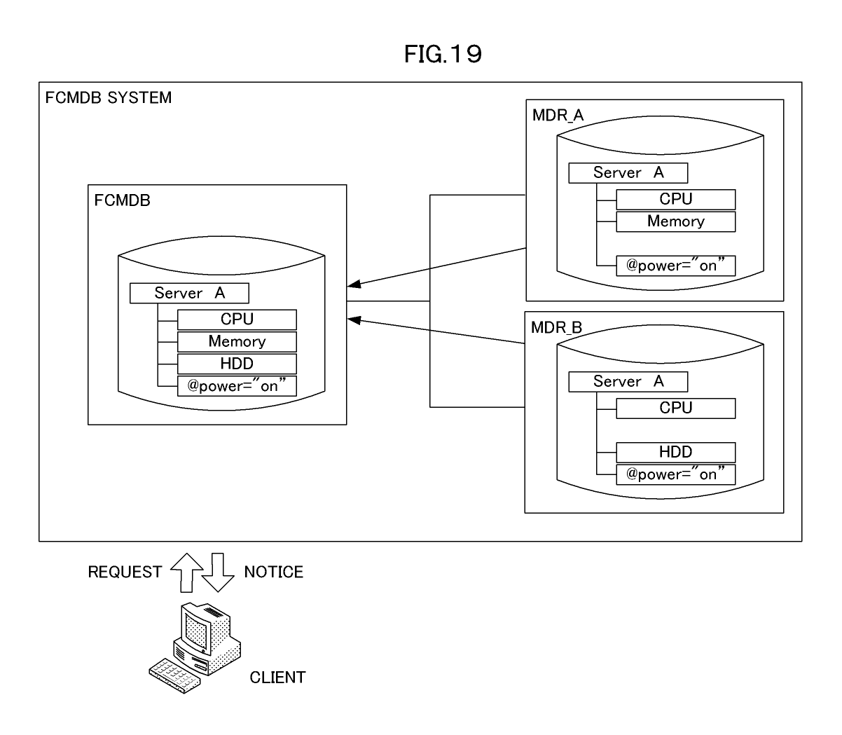

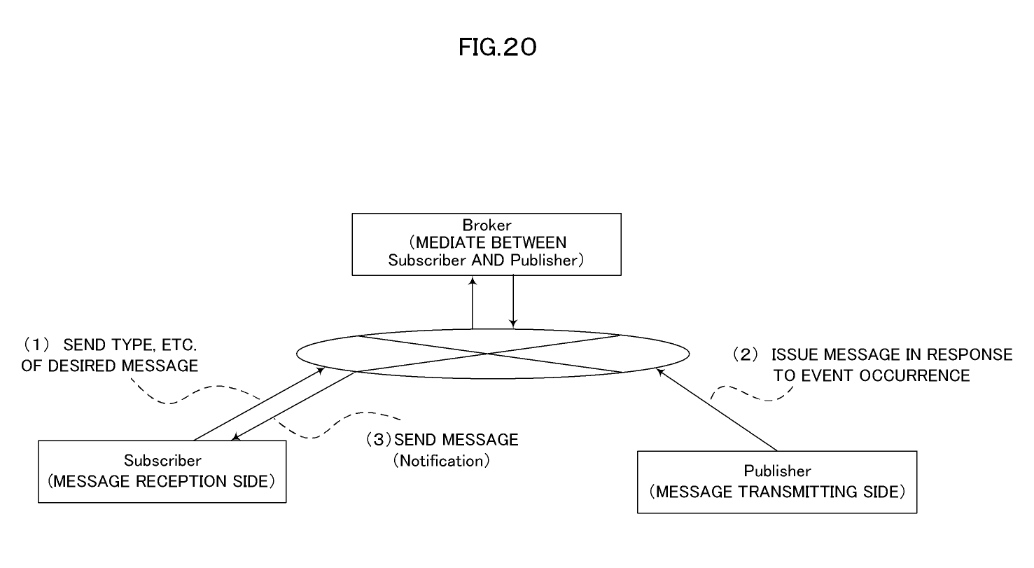

FIG. 18 is a flowchart illustrating an example of the discarding, combining, demanding processing of Notification performed by the Notification processing determination unit 215.

The Notification reception unit 214 receives Notification from the MDR and actives processing of the Notification processing determination unit 215.

The Notification processing determination unit 215 refers to the Notification stand-by DB 207 according to a Subscription ID corresponding to Notification described in the Notification and determines a stand-by item (S21).

The Notification processing determination unit 215 determines presence/absence of a stand-by item (S22). In the case where there is no stand-by item (NO in S22), the flow advances to step S26; while in the case where there exists any stand-by item (YES in S22), the Notification processing determination unit 215 deletes the detected stand-by item from the Notification stand-by DB 207 (S23) and determines whether processing to be performed for the stand-by item is discarding or not (S24). When determining that the processing is not discarding (NO in S24), the Notification processing determination unit 215 combines Notification with preceding Notification (S25, resource information processing step). In the case where the processing is discarding (YES in S24), this flow is ended.

Then, the Notification processing determination unit 215 refers to the Notification association DB 206 according to the content of Notification and searches for the subsequent Notification candidate (S26).

The Notification processing determination unit 215 determines presence/absence of the subsequent Notification (S27). When determining that there exists the subsequent Notification (YES in S27), the Notification processing determination unit 215 adds information of the detected subsequent Notification to the Notification stand-by DB 207 (S28, resource information processing step).

Then, the Notification processing determination unit 215 determines whether the processing of the subsequent Notification is discarding or not (S29). When determining that the processing is not discarding (NO in S29), which means that the processing is combining, so the Notification processing determination unit 215 instructs the Notification demanding unit 217 to demand the subsequent Notification (S30, resource information processing step), and this flow is ended.

On the other hand, in the case where there exists no subsequent Notification (NO in S27), or in the case where the processing of the Subsequent Notification is discarding (YES in S29), the Notification processing determination unit 215 instructs the Notification communication unit 216 to transmit the Notification (S31, resource information processing step), and this flow is ended.

Although not illustrated, the MDR that has received the demand from the Notification demanding unit 217 according to step S30 confirms a resource to be monitored corresponding to the Notification and sends the Notification to the Notification reception unit 214 through the Notification communication unit 312.

According to the above discarding processing of Notification, it is possible to reduce the redundant content of Notification to thereby reduce load on the Subscriber. Further, according to the above combining processing of Notification, it is possible to reduce the number of times of communication while retaining a plurality of contents of Notifications close to or associated with each other to thereby reduce burden on a communication network and, in addition, it is possible to grasp association among Notifications, allowing high-level processing to be performed by the Subscriber. Further, according to the above demanding processing, it is possible to intentionally urge transmission of associated subsequent Notification from even the MDR which is a Publisher that does not perform monitoring with a sufficient frequency or middle wear behind the MDR, thereby making the processing by the Subscriber accurate.

According to the present embodiment, the destination to which Subscription is sent is limited to the MDR that manages a change in the monitoring target, reducing load involved in the confirmation processing of the monitoring target which has conventionally been performed in the MDR unrelated to the monitoring target. Further, since unnecessary Notification is not issued, load on the Broker that mediate Notification is reduced.

Further, according to the present embodiment, redundant one of the Notifications distributed, with respect to the same event, from a plurality of MDRs is discarded, thereby reducing load on the Subscriber.

Furthermore, according to the present embodiment, it is possible to reduce the number of times of communication because of distribution of Notification obtained by combination while retaining a plurality of contents of Notifications close to or associated with each other. Thus, burden on a communication network may be reduced and, in addition, it is possible to grasp association among events since the contents of Notifications are combined, allowing high-level processing to be performed by the Subscriber.

Still furthermore, according to the present embodiment, it is possible to intentionally urge transmission of associated subsequent Notification from even the MDR which is a Publisher that does not perform monitoring with a sufficient frequency or middle wear behind the MDR, thereby making the processing by the Subscriber accurate.

The present invention may be embodied in various forms, without departing from the spirit or the main feature. Therefore, the aforementioned embodiments are merely illustrative of the invention in every aspect, and not limitative of the same. The scope of the present invention is defined by the appended claims, and is not restricted by the description herein set forth. Further, various changes and modifications to be made within the scope of the appended claims and equivalents thereof are to fall within the scope of the present invention.

Further, it is possible to provide a program that allows a computer constituting the information processing apparatus to execute the above steps as an information processing program. By storing the above program in a computer-readable storage medium, it is possible to allow the computer constituting the information processing apparatus to execute the program. The computer-readable storage medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; and another computer and database thereof.

According to the present invention, it is possible to reduce load involved with check processing of the monitoring target triggered by transmission of Subscription, to reduce communication amount involved with the distribution of Notification, and to utilize association among a plurality of events concerning the configuration information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions has(have) been described in detail, it should be understood that the various changes, substitutions, and alterations could be made hereto without departing from the spirit and scope of the invention.

What is claimed is:

1. An information processing apparatus capable of managing a plurality of resources in a distributed manner and connecting to a plurality of devices sending resource information concerning the plurality of managed resources, the information processing apparatus comprising:
a specification information reception unit that receives specification information for specifying a predetermined one of the plurality of resources;
a determination unit that determines a device managing the resource specified by the specification information from among the plurality of devices based on the specification information received by the specification information reception unit;
a specification information notification unit that sends the specification information to the device that has been determined, by the determination unit, to manage the resource specified by the specification information;
an association unit that associates plural pieces of resource information with one another based on the sent resource information; and
a resource information processing unit that executes predetermined processing for the resource information based on the association among the plural pieces of resource information associated by the association unit.

2. The information processing apparatus according to claim 1, wherein
as the predetermined processing performed based on the association among the plural pieces of resource information, the resource information processing unit extracts preceding resource information from among plural pieces of resource information concerning the same resource for sending as notification and discards subsequent resource information.

3. The information processing apparatus according to claim 1, wherein
as the predetermined processing performed based on the association among the plural pieces of resource information, the resource information processing unit creates resource information by combining the contents of a plurality of different resource information associated with one another.

4. The information processing apparatus according to claim 1, wherein
as the predetermined processing performed based on the association among the plural pieces of resource information, the resource information processing unit demands notification of the subsequent resource information from a device that manages a resource associated with the subsequent resource information in the plurality of different resource information associated with one another, which is expected to be sent as notification associated with the preceding resource information in response to the notification of the preceding resource information.

5. The information processing apparatus according to claim 1, wherein
the determination unit determines a device that manages a resource specified by the specification information based on device information in which the resource and a device that manages the resource are associated with each other.

6. The information processing apparatus according to claim 1, wherein the association unit performs the association among the plural pieces of resource information based on the frequency with which a combination of predetermined resource information and resource information different from the predetermined resource information in which the data-structural distance between resources concerning the both resource information falls within a predetermined range appears within a predetermined time period.

7. The information processing apparatus according to claim 5, wherein
the device information is information having a hierarchical structure concerning the correlation among the plurality of resources, and
in the case where there is no device information corresponding to a resource specified by the specification information, the determination unit determines a parent resource of the resource specified by the specification information with use of the hierarchical structure of the device information and takes over the determination of a device managing the parent resource for determination of a device managing the resource.

8. A computer readable, non-transitory medium having recorded thereon a program that causes a computer which manages a plurality of resources in a distributed manner and is capable to be connected to a plurality of devices sending resource information concerning the plurality of managed resources, to execute a process comprising:
receiving specification information for specifying a predetermined one of the plurality of resources;
determining a device managing the resource specified by the specification information from among the plurality of devices based on the specification information received by the receiving;
sending the specification information to the device that has been determined, by the determining, to manage the resource specified by the specification information;
associating plural pieces of resource information with one another based on the sent resource information; and
executing predetermined processing for the resource information based on the association among the plural pieces of resource information associated by the associating.

9. The computer readable, non-transitory medium according to claim 8, wherein
as the predetermined processing performed based on the association among the plural pieces of resource information, the executing includes:
extracting preceding resource information from among plural pieces of resource information concerning the same resource for sending as notification; and
discarding subsequent resource information.

10. The computer readable, non-transitory medium according to claim 8, wherein
as the predetermined processing performed based on the association among the plural pieces of resource information, the executing includes: creating resource information by combining the contents of a plurality of different resource information associated with one another.

11. The computer readable, non-transitory medium according to claim 8, wherein
as the predetermined processing performed based on the association among the plural pieces of resource information, the executing includes: demanding notification of the subsequent resource information from a device that manages a resource associated with the subsequent resource information in the plurality of different resource information associated with one another, which is expected to be sent as notification associated with the preceding resource information in response to the notification of the preceding resource information.

12. The computer readable, non-transitory medium according to claim 8, wherein
the determining determines a device that manages a resource specified by the specification information based on device information in which the resource and a device that manages the resource are associated with each other.

13. The computer readable, non-transitory medium according to claim 8, wherein
the associating performs the association among the plural pieces of resource information based on the frequency with which a combination of predetermined resource information and resource information different from the predetermined resource information in which the data-structural distance between resources concerning the both resource information falls within a predetermined range appears within a predetermined time period.

14. The computer readable, non-transitory medium according to claim 12, wherein
the device information is information having a hierarchical structure concerning the correlation among the plurality of resources, and
in the case where there is no device information corresponding to a resource specified by the specification information, the determining determines a parent resource of the resource specified by the specification information with use of the hierarchical structure of the device information and takes over the determination of a device managing the parent resource for determination of a device managing the resource.

15. An information processing method employed in an information processing apparatus capable of managing a plurality of resources in a distributed manner and connecting to a plurality of devices sending resource information concerning the plurality of managed resources, the information processing method comprising:
receiving specification information for specifying a predetermined one of the plurality of resources;
determining a device managing the resource specified by the specification information from among the plurality of devices based on the specification information received by the receiving;
sending the specification information to the device that has been determined, by the determining, to manage the resource specified by the specification information;
associating plural pieces of resource information with one another based on the sent resource information; and
executing predetermined processing for the resource information based on the association among the plural pieces of resource information associated by the associating.

16. The information processing method according to claim 15, wherein as the predetermined processing performed based on the association among the plural pieces of resource information, the executing includes:
extracting preceding resource information from among plural pieces of resource information concerning the same resource for sending as notification; and
discarding subsequent resource information.

17. The information processing method according to claim 15, wherein
as the predetermined processing performed based on the association among the plural pieces of resource information, the executing includes: creating resource information by combining the contents of a plurality of different resource information associated with one another.

18. The information processing method according to claim 15, wherein
as the predetermined processing performed based on the association among the plural pieces of resource information, the executing includes: demanding notification of the subsequent resource information from a device that manages a resource associated with the subsequent resource information in the plurality of different resource information associated with one another, which is expected to be sent as notification associated with the preceding resource information in response to the notification of the preceding resource information.

19. The information processing method according to claim 15, wherein
the determining determines a device that manages a resource specified by the specification information based on device information concerning the resource and a device that manages the resource.

20. The information processing method according to claim 15, wherein
the associating performs the association among the plural pieces of resource information based on the frequency with which a combination of predetermined resource information and resource information different from the predetermined resource information in which the data-structural distance between resources concerning the both resource information falls within a predetermined range appears within a predetermined time period.

21. An information processing apparatus capable of managing a plurality of resources in a distributed manner and connecting to a plurality of devices sending resource information concerning the plurality of managed resources, the information processing apparatus comprising:
a processor, wherein the processor executes a process comprising:
receiving specification information for specifying a predetermined one of the plurality of resources;
determining a device managing the resource specified by the specification information from among the plurality of devices based on the specification information received by the receiving;
sending the specification information to the device that has been determined, by the determining, to manage the resource specified by the specification information;
associating plural pieces of resource information with one another based on the sent resource information; and
executing predetermined processing for the resource information based on the association among the plural pieces of resource information associated by the associating.
